(19) United States
(12) Patent Application Publication
(10) Pub. No.: US 2020/0068793 A1
(43) Pub. Date: Mar. 5, 2020

(54) SACHET FOR ORGANIC FERTILIZER IN POWDER

(71) Applicant: Edisio Lopes Leite, Curitiba - Parana (BR)

(72) Inventor: Edisio Lopes Leite, Curitiba - Parana (BR)

(21) Appl. No.: 16/178,582

(22) Filed: Dec. 16, 2018

(30) Foreign Application Priority Data
Aug. 31, 2018 (BR) MU 202018067410

(51) Int. Cl. A01C 15/00

(52) U.S. Cl. CPC A01C 15/00

(57) ABSTRACT

Sachet for organic fertilizer in powder for the fertilization of plants in gardens, orchards, vegetable gardens and pots of residences, businesses or commercial establishments, among many places which are made of permeable material, TNT-non-woven fabric, or in filter paper, and is presented in rectangular, square or cylindrical format characterized in that it is constituted by individually sealed container (1), formed by an union of the front and rear faces wherein its perimeter edges (2), undergo a homogeneous hot or pressure closing (3) containing an organic powder (4) contained therein.

### INTRODUCTION

The present Utility Model patent descriptive report relates to Organic Powder Fertilizer Sachet, hereinafter referred to as Sachet, which refers to an individualized form for fertilization of ornamental or fruit plants, which is constituted by an individual bag, made of permeable material, of TNT (non-woven fabric) or of filter paper.

The physical conformation or presentation of the sachet may be rectangular, square or cylindrical, where the product, after being conditioned inside, is hermetically sealed at its perimeter edges, so that the powder of the fertilizer inside it is diluted and drained slow when it is positioned at the feet of the plants and watered for an average period of three months for each sachet.

### 1. APPLICATION FIELD

The field of application of this Sachet, refers to the area of agriculture, floriculture and the like, more specifically in places such as gardens, cultivars and gardens, among others.

### 2. PURPOSE

The purpose of this Sachet, according to its own name, is to fertilize plants, whether in the gardens of companies, residences or commercial establishments, since whenever powdered or with rainwater, the powder contained Sachet will be diluted slowly with the presence of water, helping the development of plants by being an organic product, composed of Nitrogen, Potassium, Calcium and other elements for their healthy growth.

### 3. PROBLEMS TO BE SOLVED

Nowadays, the use of fertilizers for the most varied localities, orchards, pots, vegetable gardens and gardens, is widely known, mainly Organomineral type fertilizers presented in glasses containing concentrated doses of 5 ml to be diluted in one liter of water, which will be marketed as a sachet, but to date no sachets have been produced with organic fertilizer powder diluted when it is irrigated, whether it is natural (rainwater) or induced (irrigated), i.e., organic fertilizer with controlled release.

### 4. STATE OF THE TECHNIQUE

In order to market a product endowed with its own developmental characteristics, previous research was carried out with the INPI Data Bank and the following document was found:
BR 10 2016 018356-1 deposited on 9 Aug. 2016 and published on 6 Mar. 2018 under the title “PROTECTIVE DEVICE WITH SUPPLY VEHICLE INPUT SACHET AND METHOD FOR APPLYING INSECTICIDE FOR SHANTS AND PLANTS IN GENERAL. It consists of a plate (2) of varying dimensions, made up of known and suitable materials such as biodegradable paperboard, paper and plastic provided with a radial slit (3) which terminates in an orifice (3) where the stem is fitted (4) containing in its perimeter at least one sachet (5) permeable containing the beneficial ingredient to the plant, being the method the placement of fluid agents in the gel state (6), paste, cream or the like in a cone-shaped shape taking place in the vicinity of the orifice (3), and stem of the plant of a specific insecticide carrier to control ants of the genders Atta and Acromyrmex, and indirectly, to combat Termite termitidae and Rhinotermitadae termites.

From the analysis of the document found it is verified that it only demonstrates the General State of the Technical, reason for which we consider that there are no technical or legal impediments to the granting of the requested privilege.

### 5. BENEFITS

In general, the use of individual sachets of any type of product is practical and economical since the user makes use only in necessary quantities.

Based on the principle above, the depositor in analyzing the existing problems, lack of sachets containing organic fertilizer controlled release and time of validity determined, in this case, the considered period is 03 months, considering a rainy season with rainfall within the national statistics.

Because they are manufactured in TNT or filter paper, the packaging becomes a recyclable and economically viable product.

### 6. TECHNICAL DIFFERENTIAL

In order to solve the existing problems, the author conceived the sachet made up of individual sachet made of permeable non-woven fabric, TNT or filter paper which has a square or cylindrical rectangular shape.

The packaging consists of two faces of non-woven fabric, TNT, forming a sachet, that is, a sachet where in its interior, the organic fertilizer powder is conditioned;

The manufacture is realized by the union of the perimeter edges by process of hot glue, term adherence, engraved or other forms that better converge in its industrial production.

The packaging will be filled by means of automatic dosing process with simultaneous closing of the edges of the packaging, using modern equipment equipped with electronic weighing.

Due to the fact that the fertilizer powder is packaged in the bag, the size of the packaging is reduced, thus facilitating its handling and accommodation, allowing less time and labor in the fertilization of the plants in gardens and gardens in general.

The average period of validity is 03 months for each sachet, only irrigating, when necessary, only by placing the sachet in the pot of the plants, in a simple and manual way, that is, corresponds to organic fertilizer with controlled release.

### 7. DESCRIPTION OF THE FIGURES

For a total and complete visualization of how the sachet in question is constituted, follow the accompanying illustrative drawings, to which references are made as follows:

FIG. 1: Represents perspective view of the sachet;

FIG. 2: Illustrates frontal and/or posterior view;

FIG. 3: Corresponds to left side view or right of the sachet;

FIG. 4. Illustrated view in longitudinal section of the sachet;

FIG. 5. Shows perspective, showing the open sachet With organic fertilizer powder inside

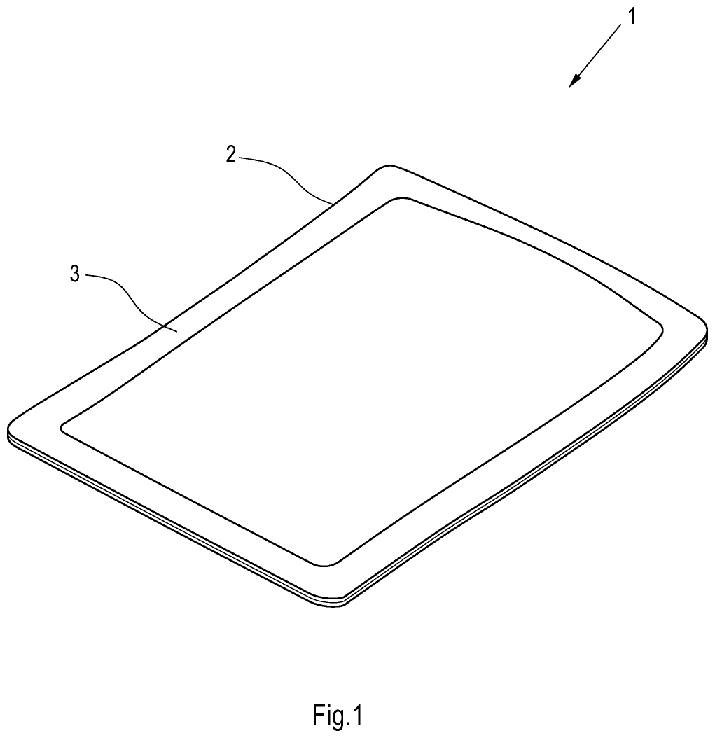

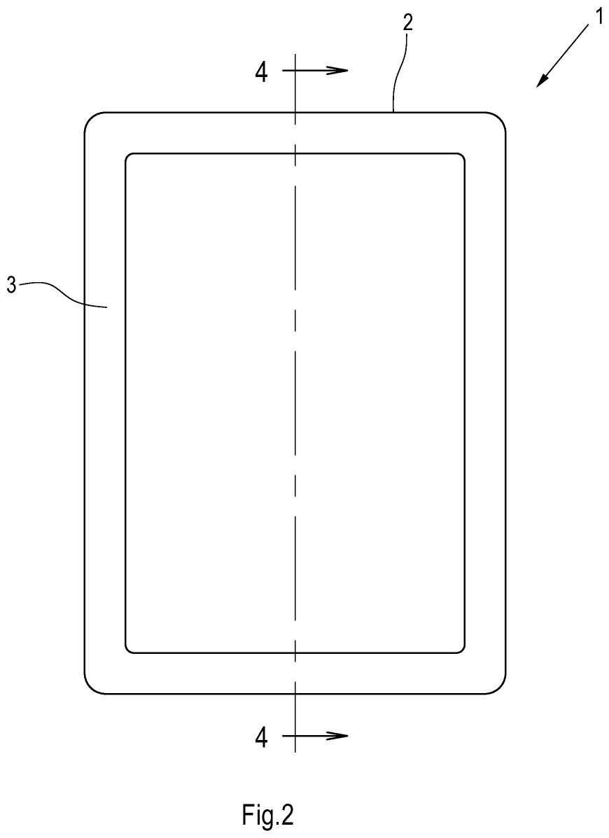

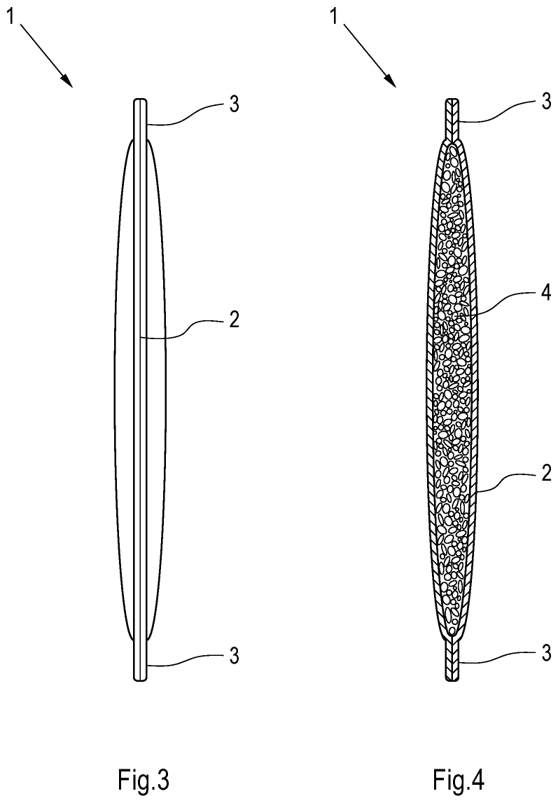

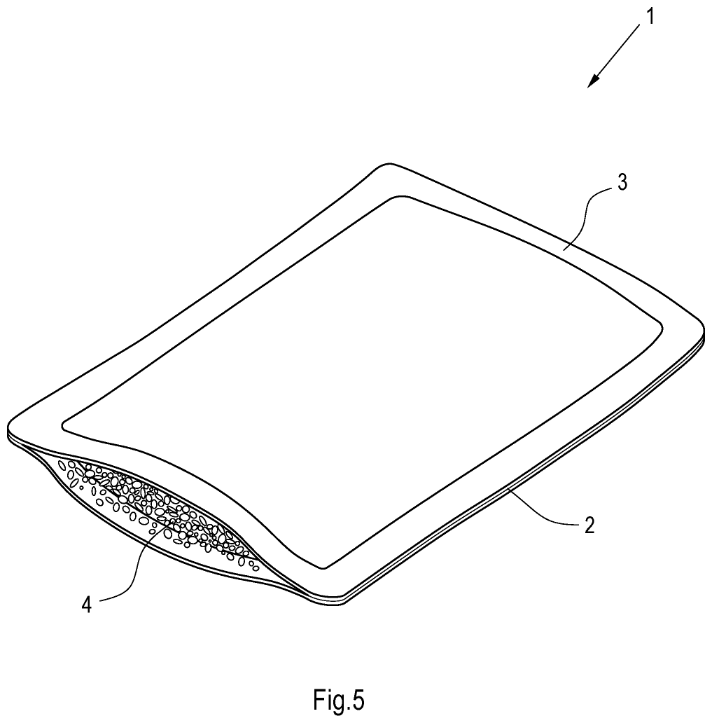

### 8. DESCRIPTION

As is apparent from the accompanying drawings which form an integral part of this report, Sachet, (1) is intended for planting, whether in gardens, orchards, vegetable gardens and pots, or in homes, businesses or establishments commercial, among many places.

It is one of the objectives of this patent to provide an organic product that contains nitrogen, potassium, calcium and other natural elements and necessary for the healthy growth of plants, to use rainwater whenever climatic conditions allow, otherwise, the plant with the sachet on your feet should be irrigated.

Another objective of this Sachet is to make available a product, containing organic fertilizer with controlled release.

In accordance with what is illustrated in the figures above, the sachet (1) is characterized in that it is constituted by a sealed individual package (1) which is made of permeable material, TNT (non-woven fabric) or filter paper, is shown in rectangular, square or cylindrical form and is formed by the union of the front and rear faces where their edges (2) undergo a hot homogeneous closure (3), pressure or other shapes, taking the package (1) or sachet hermetically sealed, containing organic fertilizer powder (4) packed inside.

Sachet (1) is practical in its set of functionality and applicability, providing a practical and hygienic way for packaging and reducing costs for consumers, reducing and even eliminating at one time the possibility of contamination of plants by excess quantity of fertilizer.

### 9. CONCLUSION

It is verified by everything that has been described and illustrated that it is Sachet for Organic Fertilizer in Powder (1), which fits perfectly within the norms that govern the patent of Utility Model, deserving for what has been described and illustrated the requested privilege.

1. Sachet for organic fertilizer in powder for the fertilization of plants in gardens, orchards, vegetable gardens and pots of residences, businesses or commercial establishments, among many places which are made of permeable material, TNT-nonwoven fabric, or in filter paper, and is presented in rectangular, square or cylindrical format characterized in that it is constituted by individually sealed container (1), formed by an union of the front and rear faces wherein its perimeter edges (2), undergo a homogeneous hot or pressure closing (3) containing an organic powder (4) contained therein.
